(19) United States
(12) Patent Application Publication
(10) Pub. No.: US 2008/0022490 A1
(43) Pub. Date: Jan. 31, 2008

(54) Door Closer with a Drive

(75) Inventors: Lothar Ginzel, Schwerte (DE); Volker Bienek, Dortmund (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/586,077

(22) PCT Filed: Nov. 30, 2004
(86) PCT No.: PCT/EP04/13580

§ 371 Date: Aug. 29, 2006

(30) Foreign Application Priority Data
Jan. 16, 2004 (DE) 10 2004 002 655.6

(51) Int. Cl. E05F 3/04; E05F 3/22

(52) U.S. Cl. 16/51

(57) ABSTRACT

A door closer includes a housing; a shaft supported in the housing and connectable to a door; a brake piston supported in the housing and charging the shaft, the brake piston and the housing defining a first space away from the shaft; a blocking member; a spring loading the blocking member and extending orthogonally from the housing; and a pump for pumping brake fluid to or from the first space. The pump is disposed in a second space formed between the housing and the spring. The shaft is lockable in a position by the blocking member.

The invention relates to a door closer including an electro-hydraulical/electro-mechanical drive and a housing, in which a shaft for the connection to a door or the like is supported, the shaft being lockable, in at least one position, by means of a spring-loaded blocking member.

Such door closers are very well known. Usually such door closers present a housing, in which a shaft, that is connectable to a door or the like, a spring-loaded blocking member and a brake piston are disposed. The blocking member and the brake piston are substantially located in-line on opposite sides of the shaft such that the housing presents an overall elongate shape. In many applications however, it is difficult to accommodate such housing shape as, particularly in the area of the floor very often an elongate cavity can not be provided for the housing. Such a door closer is revealed in DE 40 38 720 C2 as an overhead door closer and in DE 27 55 787 A1 as a floor spring.

Therefore it is an object of the present invention to design a door closer including a drive, which presents a more compact housing shape and is thus easier to accommodate, particularly in the floor, and is likewise suitable for single action doors.

This object is achieved with a door closer including a drive of the above described type in that the spring, loading the blocking member, extends orthogonally from the housing and in that a pump and/or a drive motor are disposed in the space formed between the housing and the spring.

A substantially square design of an inventive drive is achieved on account of this construction, which is fairly easy to install even with mounting conditions, where space is critical. This is particularly the case with single action doors, where the length of the door closer from the closer shaft to the adjacent door frame is reduced to a minimum dimension. Such a drive automatically opens the door, either electro-mechanically or electro-hydraulically, the closing operation of the door being effected via a spring accumulator.

The dependent claims represent further embodiments of the inventive subject matter.

The main part (the housing) consists of a square body, to which a tube is secured at a right angle in relation to the axis of the body. Another shorter tube, being longitudinally displaceable and having a bottom, to which the support carrying the roller is attached, is located inside this tube. Both tubes fitted into each other present a steel planchet between them. The latter reduces abrasion simultaneously allowing to avoid heat treatment of the tubes.

According to a preferred further development, the spring is supported within a preferably tube-shaped cartridge, extending orthogonally from the housing, which cartridge is interchangeably connected to the housing for example. This does not only allow for arranging all components of the drive within minimum space, but also for an adaptive mounting of the bushing accommodating the spring, such that the bushing can be quickly and easily exchanged.

n order to further improve exchangeability of the individual components of the inventive drive, the pump and/or the drive motor are advantageously accommodated in a casing, which is detachably (interchangeably) mounted at the housing respectively at the tube-shaped bushing (cartridge).

The structure of the blocking member is particularly simple, if, according to one advantageous embodiment, the blocking member presents a cup-shaped insert, which is displaceably supported within the tube-shaped cartridge. On account of this disposition, a tilt-free guiding of the blocking member inside the cartridge is ensured.

In an advantageous further development, a support carrying a roller, which cooperates with the shaft, extends from the bottom of the cup-shaped insert into the housing.

In order to maintain the shaft, which is connected to the door or the like, in a determined position, the cup-shaped insert is advantageously loaded into the direction of the housing by means of a spring disposed in the bushing. Therefore, a reliable contact of the blocking member at the shaft is guaranteed in each position.

In order to guarantee a low-friction guiding of the cup-shaped insert within the bushing at reduced wear, according to a preferred embodiment, a low-friction and/or wear reducing coating or liner, e.g. made from steel, is provided between the bushing and the cup-shaped insert.

According to an advantageous embodiment, for damping the movement of the shaft, the shaft is charged by means of a spring-loaded brake piston, which is supported within the housing.

For achieving a good sealing action of the brake piston in relation to the housing, advantageously a seal is provided between the walling of the housing and the brake piston.

With the intention to maintain the door or the like in a defined position, according to a preferred further development, the brake piston is lockable in a pre-determined position via a valve arrangement.

Advantageously, the valve arrangement presents a regulating valve and a shut-off valve affecting the flow of the regulating valve. Thus, in a simple manner it is possible to control, respectively to stop the flow of brake fluid, such that movement of the brake piston is no longer possible and that the door is locked in a determined position.

However, to allow for closing the door or the like when the door is blocked, according to an advantageous embodiment, the shut-off valve automatically opens at excess pressure and the door closes on account of the spring accumulator.

For releasing the blocking of the door, the shut-off valve can be electro-magnetically actuated as well.

In order to guarantee a non-positive abutment of the brake piston at the shaft, according to one preferred embodiment, the brake piston is provided with a roller, which charges an eccentric disc which is disposed at the shaft.

As an alternative, the brake piston may be in communication with the shaft by means of a rocker and an eccentric disc. This construction presents the advantage of a uniform path through a forced guidance.

Further features and advantages of the inventive drive will result from the following description of preferred exemplary embodiments, in which:

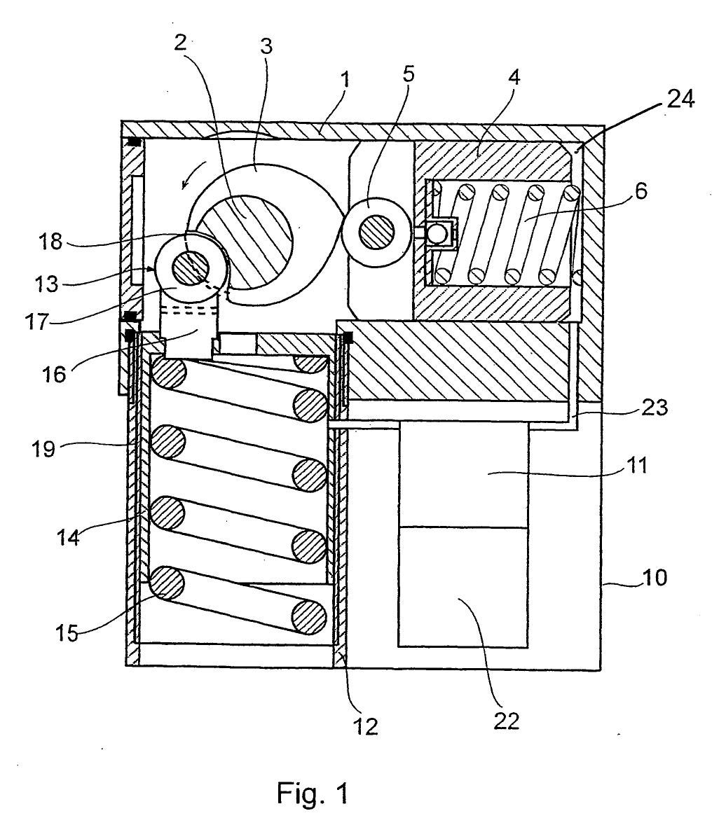

FIG. 1: shows a cross-section through the inventive door closer;

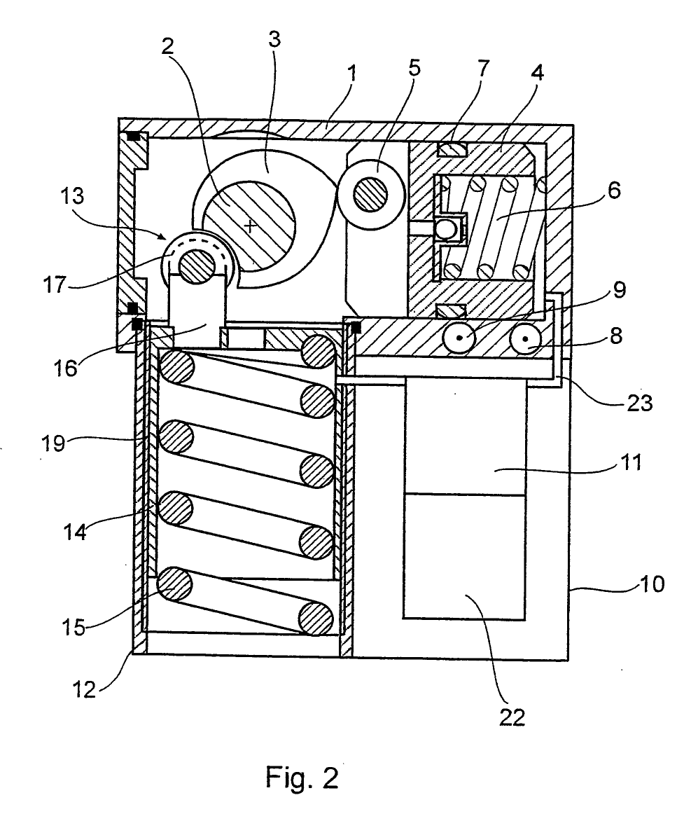

FIG. 2: shows another cross-section through the inventive door closer, and

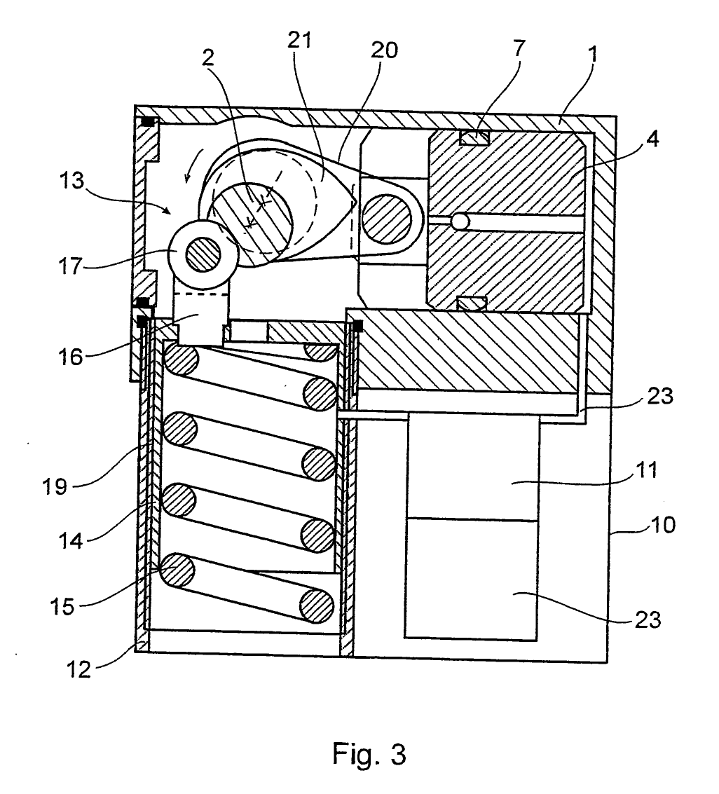

FIG. 3: shows a cross-section through another embodiment of the inventive door closer.

The inventive door closer is represented in the FIGS. 1 to 3 only to an extent that is of interest for the present invention.

The inventive door closer presents a substantially rectangular housing 1, in which a shaft 2 is supported, which is connectable to a door or the like. The shaft 2 presents an eccentric disc 3, which is in engagement with a roller 5 supported at a brake piston 4.

The brake piston 4 in return is longitudinally and displaceably supported in the housing 1, whereby it is being urged into the direction of the shaft 2 by means of a spring 6, which is likewise supported within the housing 1.

At the brake piston 4, a seal 7, which bears against the walling of the housing 1, is disposed in a peripheral groove. A regulating valve 8 is provided at the end of the housing 1 remote from the shaft 2, which valve affects the movement of the brake piston 4 by regulating the flow of the brake fluid within the housing 1. Thus, e.g. the door or the like can be locked in a determined position, for example in the open position.

In order to allow for intentionally moving the door, in the event the door or the like is being blocked, a shut-off valve 9 is provided, which automatically closes upon intentionally moving the door. For this purpose a small piston or a valve seat may be provided for example, which, on account of friction of an O-ring at the valve seat, prevents brake fluid from flowing, however, which will be displaced when excess pressure builds up in the brake fluid, for example through intentionally moving the door, such that the blocking is released and the door can be moved. Basically, an electromagnetic actuating of the shut-off valve 9 is possible as well, such that the inventive door closer can be used in emergency and evacuating routes.

A tube-shaped bushing 12 or a cartridge extends orthogonally to the housing 1, which bushing is detachably disposed at the housing 1 and in which a blocking member 13 is longitudinally and displaceably supported. The blocking member 13 has a cup-shaped insert 14, which is supported within the tube-shaped bushing 12 and is urged into the direction of the shaft 2 by means of a spring 15, which is likewise supported within the bushing 12.

A casing 10, in which a pump 11 and/or a drive motor 22 are accommodated, is provided in the space formed between the housing 1 and the tube-shaped bushing 12. The overall door closer has a substantially square form on account of this design. The casing 10 is detachably mounted at the housing 1, respectively at the tube-shaped bushing 12. The pump 11, via hydraulic lines 23, is in communication with the inside of the housing 1 and with the inside of the tube-shaped bushing 12.

When using a motor or a combination of motor and pump, the door closer can thus automatically open the door as well, as an additional feature. The subsequent closing operation can be realized via the existing spring energy.

A support 16 protrudes from the bottom of the cup-shaped insert 14 into the direction of the housing 1, which support, at the front end thereof, carries a roller 17, which engages for example into a recess 18 at the shaft 2, respectively at the eccentric disc 3.

In order to ensure the most friction-less and the least wearing movement of the cup-shaped insert 14 in the tube-shaped bushing 12, a friction reducing and/or wear reducing coating or insert 19 is provided, for example made from steel.

FIG. 3 depicts an alternative embodiment of the inventive door closer, in which the brake piston 4 is in communication with the shaft 2 via a rocker 20 and an eccentric disc 21.

The inventive door closer is preferably intended for use as a floor spring; however, it is suitable for other mounting situations as well.

### REFERENCES

1 housing

2 shaft

3 eccentric disc

4 brake piston

5 roller

6 spring

7 seal

8 regulating valve

9 shut-off valve

10 casing

11 pump

12 tube-shaped bushing

13 blocking member

14 cup-shaped insert

15 spring

16 support

17 roller

18 recess

19 coating or insert

20 rocker

21 eccentric disc

22 drive motor

23 hydraulic line

1-17. (canceled)

18. A door closer comprising:
a housing;
a shaft supported in the housing and connectable to a door;
a brake piston supported in the housing and charging the shaft, the brake piston and the housing defining a first space away from the shaft;
a blocking member;
a first spring loading the blocking member and extending orthogonally from the housing; and
a pump for providing at least one of functions of pumping brake fluid to the first space and pumping brake fluid from the first space, the pump being disposed in a second space formed between the housing and the first spring,
wherein the shaft is lockable in a position by the blocking member.

19. The door closer of claim 18, further comprising a drive motor for driving the pump, the drive motor being disposed in the second space.

20. The door closer of claim 18, further comprising a tube-shaped bushing which is detachably connected to the housing and extends orthogonally therefrom, the first spring being supported in the tube-shaped bushing.

21. The door closer of claim 19, further comprising a tube-shaped bushing which is detachably connected to the housing and extends orthogonally therefrom, the first spring being supported in the tube-shaped bushing.

22. The door closer of claim 21, further comprising a casing detachably connected to the housing and the tube-shaped bushing, the pump and the drive motor being received in the casing.

23. The door closer of claim 21, further comprising a casing detachably connected to the housing and the tube-shaped bushing, the drive motor being received in the casing.

24. The door closer of claim 20, wherein the blocking member comprises a cup-shaped insert displaceably supported in the tube-shaped bushing.

25. The door closer of claim 24, wherein the cup-shaped insert has a bottom facing the shaft, the blocking member further comprising a support which protrudes from the bottom of the cup-shaped insert into the housing and has a roller cooperating with the shaft.

26. The door closer of claim 24, wherein the first spring is disposed in the tube-shaped bushing and loads the cup-shaped insert in the direction of the housing.

27. The door closer of claim 24, further comprising a friction or wear reducing element between the tube-shaped bushing and the cup-shaped insert.

28. The door closer of claim 18, further comprising an eccentric disc mounted on the shaft, and a second spring which charges the brake piston toward the eccentric disc.

29. The door closer of claim 18, further comprising a seal between the housing and the brake piston.

30. The door closer of claim 18, further comprising a valve arrangement, and wherein the brake piston is lockable in a predetermined position by means of the valve arrangement.

31. The door closer of claim 30, wherein the valve arrangement comprises a regulating valve, and a shut-off valve which affects flow of the regulating valve.

32. The door closer of claim 31, wherein the shut-off valve automatically opens at a predetermined pressure.

33. The door closer of claim 31, wherein the shut-off valve is operable to be electro-magnetically actuated.

34. The door closer of claim 28, wherein the brake piston comprises a roller which engages the eccentric disc.

35. The door closer of claim 18, wherein the brake piston is coupled to the shaft by means of a rocker and an eccentric disc.
